(19) United States
(12) Patent Application Publication
(10) Pub. No.: US 2024/0290945 A1
(43) Pub. Date: Aug. 29, 2024

(54) Electrode And Method For Preparing Same

(71) Applicant: LG Energy Solution, Ltd., Seoul (KR)

(72) Inventors: Seo Jun Lee, Daejeon (KR); Hyojin Lee, Daejeon (KR); Tae Su Kim, Daejeon (KR); Hyuk Soo Lee, Daejeon (KR)

(73) Assignee: LG Energy Solution, Ltd., Seoul (KR)

(21) Appl. No.: 18/570,316

(22) PCT Filed: Jul. 7, 2022
(86) PCT No.: PCT/KR2022/009862

§ 371 Date: Dec. 14, 2023

(30) Foreign Application Priority Data
Jul. 8, 2021 (KR) 10-2021-0089425

(51) Int. Cl. H01M 4/139; B23K 26/38; H01M 4/04

(52) U.S. Cl. CPC H01M 4/139; B23K 26/38; H01M 4/0404; H01M 4/0435; H01M 4/0471

(57) ABSTRACT

A method for preparing an electrode, includes (a) designating a current collector surface into an active material layer-laminated portion and an active material-nonlaminated portion, and attaching a masking tape to the active material-nonlaminated portion; (b) laminating an active material layer on the masking tape-attached current collector; (c) forming a cutting groove on an upper surface of the active material layer along a boundary of the masking tape at the bottom and the active material; and (d) removing the masking tape along the cutting groove to form the active material-nonlaminated portion, and an electrode in which a corner portion where an upper surface of the active material layer and a side wall surface forming a thickness of the active material layer meet is formed in a right-angled shape.

### TECHNICAL FIELD

The present application claims the benefit of priority based on Korean Patent Application No. 10-2021-0089425 filed on Jul. 8, 2021, the entire contents of which are incorporated herein by reference.

The present invention relates to an electrode and a method for preparing the same, and specifically, to an electrode in which a corner portion where an upper surface of an active material layer and a side wall surface forming a thickness of the active material layer meet is formed in a right-angled shape, and a method for preparing the electrode.

### BACKGROUND ART

As demands for mobile devices, electric vehicles and the like increase, demands for secondary batteries are rapidly increasing. In particular, a lithium secondary battery having high energy density and voltage among secondary batteries has been commercialized and widely used.

A lithium secondary battery has a structure in which an electrolyte including a lithium salt is impregnated into an electrode assembly having a porous separator provided between electrodes with an active material coated on a current collector, that is, a positive electrode and a negative electrode. The electrode is prepared by forming an active material layer on a current collector after going through a mixing process of mixing/dispersing an active material, a binder and a conductor into a solvent to prepare slurry, a coating process of coating the active material slurry on a thin-film-type current collector and drying the result, and a pressing process for increasing capacity density of the electrodes completed with the coating process and increasing adhesion between the current collector and the active material.

It is known that, when applying the active material slurry on the current collector, a drag line and/or island are formed as illustrated in FIG. 2, making it difficult to form a uniform surface at an end portion of the active material layer. In addition, as illustrated in FIG. 3, a sliding portion of gradually decreasing the thickness of the active material layer is formed at the edge of the active material layer causing a problem of reducing capacity of the active material layer. In addition, when applying the slurry on both surfaces of the current collector, mismatching, which the position of the slurry coated on the upper surface and the lower surface failing to match, occurs as illustrated in FIG. 3. Such mismatching dislocates the position of active material layer when facing the positive electrode/negative electrode, and such a dislocated portion reduces efficiency of charge and discharge. Particularly, the mismatching portion may cause lithium precipitated on the negative electrode surface, and when such lithium precipitation occurs for a long period of time, a decrease in the battery capacity occurs.

Accordingly, there have been needs for methods capable of uniformly forming an end portion of an active material layer and preventing formation of a sliding portion and/or a mismatching portion.

### Prior Art Document

Japanese Laid-open Patent Publication No. 2000-251942

### DISCLOSURE

### Technical Problem

The present invention has been devised to resolve such problems of the prior art, and is directed to providing a method for preparing an electrode capable of uniformly forming an end portion of an active material layer, and preventing formation of a sliding portion and/or a mismatching portion.

In addition, the present invention is also directed to providing a method for preparing an electrode capable of forming a corner portion where an upper surface of the active material layer and a side wall surface forming a thickness of the active material layer meet in a right-angled shape.

In addition, the present invention is also directed to providing an electrode capable of increasing battery capacity by forming a corner portion where an upper surface of the active material layer and a side wall surface forming a thickness of the active material layer meet in a right-angled shape.

### Technical Solution

In order to achieve the above objects, the present invention provides a method for preparing an electrode, including:
(a) dividing a current collector surface into an active material layer-laminated portion and an active material-nonlaminated portion, and attaching a masking tape to the active material-nonlaminated portion;
(b) laminating an active material layer on the masking tape-attached current collector;
(c) forming a cutting groove on an upper surface of the active material layer along a boundary of the masking tape at the bottom and the active material; and
(d) removing the masking tape along the cutting groove to form the active material-nonlaminated portion.

In addition, the present invention provides
an electrode prepared using the preparation method of the present invention, including a current collector and an active material layer laminated on one surface or both surfaces of the current collector,
wherein a corner portion adjacent to the active material-nonlaminated portion and where an upper surface of the active material layer and a side wall surface forming a thickness of the active material layer meet includes a partial form of the cutting groove.

### Advantageous Effects

A method for preparing an electrode of the present invention is effective in uniformly forming an end portion of an active material layer, and preventing formation of a sliding portion and/or a mismatching portion.

In addition, the present invention provides a method capable of forming a corner portion where an upper surface of the active material layer and a side wall surface forming a thickness of the active material layer meet in a right-angled shape.

In addition, the electrode of the present invention is effective in increasing battery capacity by forming a corner portion where an upper surface of the active material layer and a side wall surface forming a thickness of the active material layer meet in a right-angled shape.

### DESCRIPTION OF DRAWINGS

FIG. 1 is a diagram schematically illustrating a method for forming an electrode of the prior art,

FIG. 2 is a diagram showing a problem occurring when applying an active material on a current collector according to the prior art,

FIG. 3 is a diagram schematically illustrating a sliding portion and a mismatching portion occurring when applying an active material on a current collector according to the prior art,

FIG. 4 to FIG. 6 are diagrams each illustrating one embodiment of a method for preparing an electrode of the present invention, and

FIG. 7 and FIG. 8 are diagrams each illustrating one embodiment of attaching a masking tape by a roll-to-roll process in a method for preparing an electrode of the present invention.

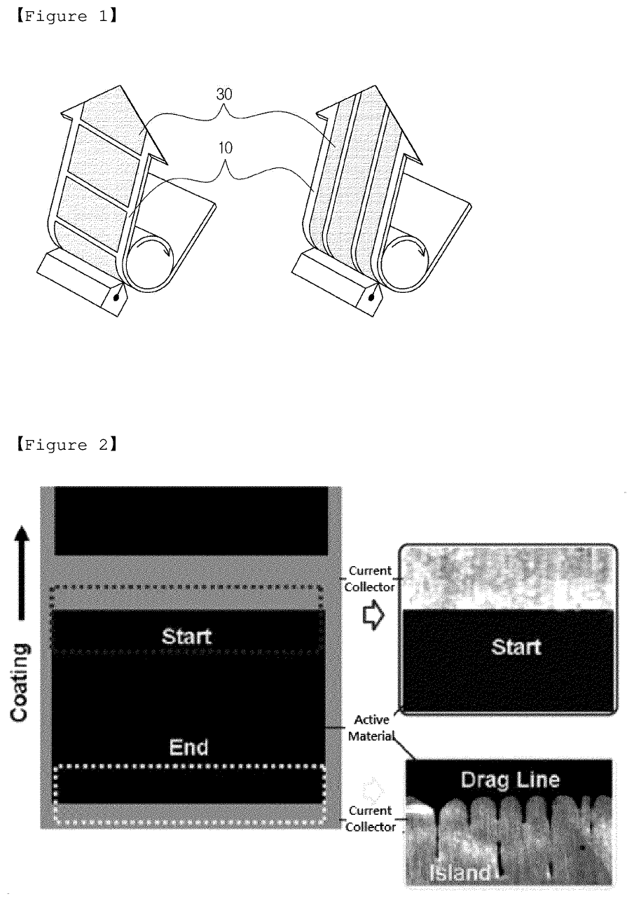

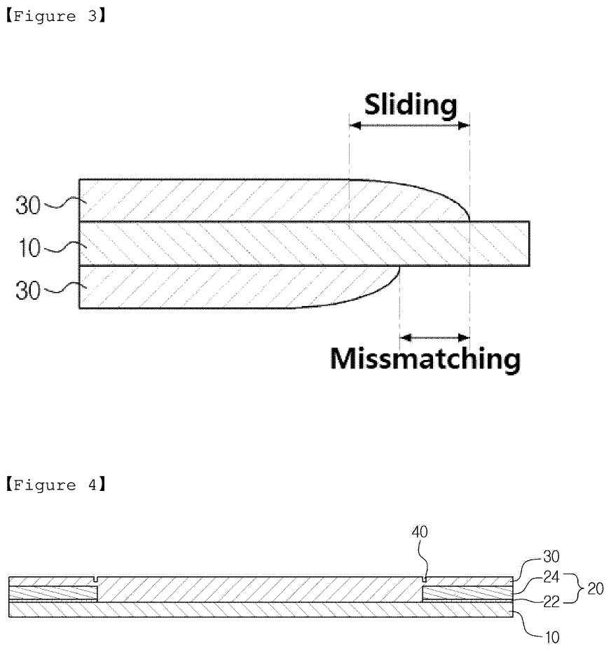

### BEST MODE

Hereinafter, the embodiments of the present invention will be described in detail with reference to accompanying drawings so that those skilled in the art may readily implement the present invention. However, the present invention may be embodied in various different forms and is not limited to the embodiments described herein. Throughout the specification, like reference numerals indicate like parts.

A method for preparing an electrode of the present invention includes:
(a) dividing a current collector surface into an active material layer-laminated portion and an active material-nonlaminated portion, and attaching a masking tape to the active material-nonlaminated portion;
(b) laminating an active material layer on the masking tape-attached current collector;
(c) forming a cutting groove on an upper surface of the active material layer along a boundary of the masking tape at the bottom and the active material; and
(d) removing the masking tape along the cutting groove to form the active material-nonlaminated portion.

In the above description, the active material-nonlaminated portion is also referred to as a “non-coating portion”, and means a portion where an electrode tap is formed.

Existing methods for preparing an electrode also disclose techniques using a masking tape, but have a disadvantage in that, when removing a masking tape after laminating an active material, the cut portion of the active material layer is not able to form a uniform surface. In other words, active material slurry forming the active material layer includes active material particles, conductor particles, a binder and the like, and by these being bound by the binder at the time when removing the masking tape to form aggregates (clumps) of various sizes, it is difficult to form a uniform cross-section of the active material layer when the active material on the upper surface of the masking tape is physically cut by removing the masking tape.

The inventors of the present invention have made extensive efforts in order to improve such disadvantages of the prior art, and have found out that such problems are significantly improved when, as illustrated in FIG. 4, forming a cutting groove 40 on an upper surface of the active material layer along a boundary between a masking tape 20 at the bottom and an active material 30, and completed the present invention.

In one embodiment of the present invention, as the masking tape 20, those known in the art may be used. As the masking tape, a pressure-sensitive adhesive tape may be preferably used, and the pressure-sensitive adhesive tape may include a film substrate 24 and a pressure-sensitive adhesive layer 22 formed on one surface of the film substrate. In this case, binding strength of the pressure-sensitive adhesive layer 22 for a current collector 10 needs to be weaker than binding strength of the pressure-sensitive adhesive layer 22 for the film substrate 24, and such a difference in the binding strength is preferred because the pressure-sensitive adhesive tape is removed without remaining on the current collector.

In one embodiment of the present invention, the cutting groove in the step (c) may be formed using a means known in the art such as a knife, and particularly, is preferably formed using a laser. This is due to the fact that, when using a knife or the like, uniformly forming a groove surface of the cutting groove is difficult, working becomes inconvenient due to active material fragments removed during the groove forming process, and quality of the active material layer may be damaged.

The shape of the cutting groove is not particularly limited, and may be an alphabet U-like shape, V-like shape or the like. In this case, the alphabet U-like shaped cutting groove may have a shape in which the bottom surface and the wall surface are formed to be perpendicular to each other.

The cutting groove may be formed to have a width of 10 to 200 μm and a depth of 10 to 200 μm, however, the cutting groove size needs to be formed differently depending on the active material layer thickness and the masking tape thickness, and is not limited to the above range.

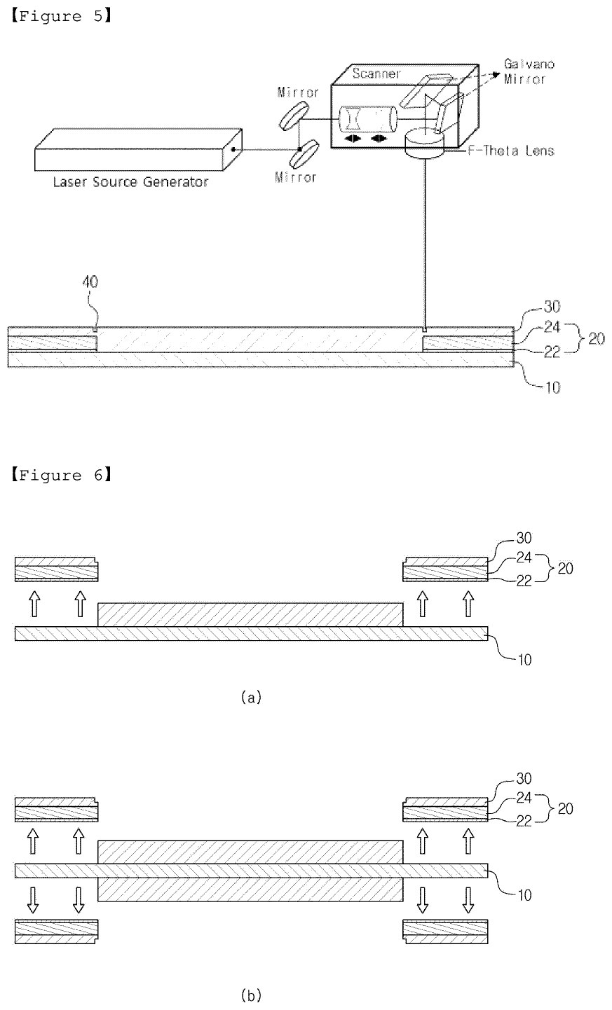

As a laser device that generates the laser, laser devices known in the art may be used. The laser device may be formed including, as illustrated in FIG. 5, a laser source generator, a delivery mirror, a laser beam width controller, a scanner unit and the like, and the scanner may include a Galvano mirror, a theta lens and the like. The laser source generator may be, for example, an IR fiber laser source generator, and the laser wavelength may be 1000 to 1100 nm and preferably 1060 to 1080 nm, but is not limited thereto.

In one embodiment of the present invention, the cutting groove may be formed using a laser after supplying moisture to the cutting groove forming site. Forming the cutting groove using a laser without supplying moisture is not preferred since a problem of active material deterioration caused by heat of the laser (generating heat affected zone) occurs. Accordingly, in the present invention, moisture is supplied in advance before forming the cutting groove by a laser, and then a laser is applied. A method of supplying moisture is not particularly limited, and, for example, moisture may be supplied by spraying water to the active material using a spray device or the like.

The moisture is, for example, preferably supplied 5 to 30 seconds prior to applying a laser. This is due to the fact that sufficient time is required for moisture to be supplied into the active material before applying a laser. However, the time is not limited to the above-mentioned range since the degree of moisture absorption varies depending on the composition of the active material.

In one embodiment of the present invention, the step of (b) laminating an active material layer may be implemented by coating the active material on the active material-laminated portion and a part or all of the upper portion of the masking tape. In addition, the step of laminating an active material may further include, after coating the active material, pressing the coated active material. The active material coating and pressing steps may be implemented using methods known in the art.

In one embodiment of the present invention, the cutting groove in the step (c) is, as illustrated in FIG. 4, preferably formed on a side of the active material positioned on the masking tape around the boundary of the masking tape and active material. The cutting groove being formed on the above-mentioned position may be advantageous for securing battery capacity because, as illustrated in FIG. 6, the cross-section of the remaining active material layer may be formed close to a right angle after removing the masking tape.

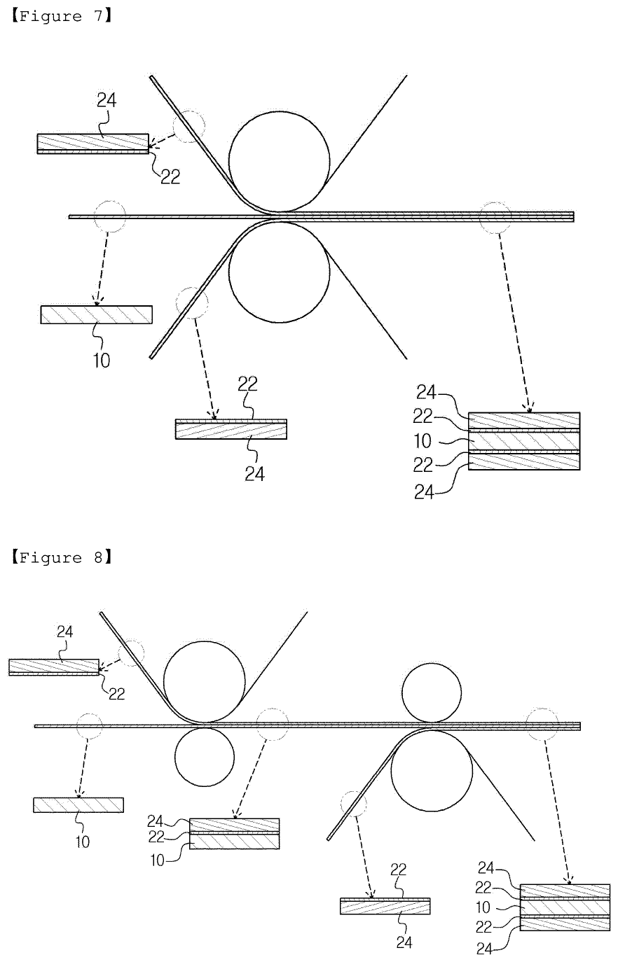

In one embodiment of the present invention, attaching the masking tape in the steps (a) to (d) may be, as illustrated in FIG. 7 and FIG. 8, implemented by a roll-to-roll process. In this case, in FIG. 7 and FIG. 8, the masking tape may include a film substrate and a pressure-sensitive adhesive layer (PSA), and a release film may be further attached to the pressure-sensitive adhesive layer. The release film may be removed in the step prior to adhering the masking tape to the current collector.

After attaching the masking tape as above, the active material may be laminated on, by a common roll-to-roll process, the current collector to which the masking tape is not attached, or the portion to which the masking tape is attached and the current collector to which the masking tape is not attached.

The roll-to-roll process may be implemented using methods known in the art.

In addition, the present invention relates to an electrode prepared using the preparation method of the present invention, including
a current collector and an active material layer laminated on one surface or both surfaces of the current collector,
wherein a corner portion adjacent to the active material-nonlaminated portion, and where an upper surface of the active material layer and a side wall surface forming a thickness of the active material layer meet includes a partial form of the cutting groove as illustrated in FIG. 6.

The corner portion where an upper surface of the active material layer and a side wall surface forming a thickness of the active material layer meet includes a partial form of the cutting groove, thereby being formed in a right-angled shape.

The right-angled shape includes a substantially right-angled shape as well as a right angle following strict criteria. Particularly, the side wall surface forming a thickness of the active material layer may be a side wall surface in a direction where an electrode tap is formed.

In addition, in one embodiment of the present invention, the electrode may be formed using the method for preparing an electrode of the present invention.

In the present invention, the current collector is a positive electrode current collector or a negative electrode current collector, and current collectors known in the art may be used without limitation. For examples, foil prepared with copper, aluminum, gold, nickel, a copper alloy, or a combination thereof may be used as the current collector.

In addition, the active material layer may be a positive electrode active material layer or a negative electrode active material layer. The active material layer may be formed as active material slurry including a positive electrode active material or a negative electrode active material and a binder, and the active material slurry may further include a conductive material, and as necessary, may also further include a dispersant.

As the positive electrode active material, the negative electrode active material, the binder and the conductive material, components known in the art may be used without limitation.

The positive electrode active material may be, for example, lithium manganese oxide, lithium cobalt oxide, lithium nickel oxide, lithium iron oxide, LiNiₓMn_{y}Co_{z}O₂ (NMC) that is a three-component positive electrode material, lithium composite oxides obtained by combining these, or the like. In a lithium-sulfur battery, a sulfur-carbon composite may be included as the positive electrode active material.

The negative electrode active material may be, for example, LiTi₂(PO₄)₃, Li₃V₂(PO₄)₃, LiVP₂O₇, LiFeP₂O₇, LiVPO₄F, LiVPO₄O, LiFeSO₄F and the like. The negative electrode active material may have a carbon coating layer formed on the surface.

The conductor may be, for example, carbon black such as Super-P, denka black, acetylene black, ketjen black, channel black, furnace black, lamp black, thermal black or carbon black; carbon derivatives such as carbon nanotubes or fullerene; conductive fibers such as carbon fibers or metal fibers; fluorocarbon, aluminum, metal powders such as nickel powder; or conductive polymers such as polyaniline, polythiophene, polyacetylene or polypyrrole, and the like.

The electrode may be a positive electrode or a negative electrode, and a method for preparing the same is not particularly limited, and the electrode may be prepared in a form in which a positive electrode active material or a negative electrode active material is bound to a current collector according to methods commonly known in the art.

The electrode may be used in a secondary battery, and for example, may be used in a lithium ion secondary battery.

Although the present invention has been described in connection with the preferred embodiments described above,
various changes and modifications may be made without departing from the gist and the scope of the present invention. Accordingly, the attached claims cover such changes and modifications as long as they fall within the gist of the present invention.

### DESCRIPTION OF SYMBOL

10: Current Collector
20: Masking Tape
22: Pressure-Sensitive Adhesive Layer
24: Film Substrate
30: Active Material
40: Cutting Groove

1. A method for preparing an electrode, comprising:
(a) designating a current collector surface into an active material layer-laminated portion and an active material-nonlaminated portion, and attaching a masking tape to the active material-nonlaminated portion;
(b) laminating an active material layer on the masking tape-attached current collector;
(c) forming a cutting groove on an upper surface of the active material layer along a boundary of the masking tape at a bottom and the active material; and
(d) removing the masking tape along the cutting groove to form the active material-nonlaminated portion.

2. The method of claim 1, wherein the cutting groove in step (c) is formed using a laser.

3. The method of claim 2, wherein the cutting groove is formed using a laser after supplying moisture to the cutting groove forming site.

4. The method of claim 1, wherein step (b) includes active material coating and pressing.

5. The method of claim 1, wherein the cutting groove in step (c) is formed on a side of the active material positioned on the masking tape around the boundary line of the masking tape and active material.

6. The method of claim 1, wherein the masking tape is a pressure-sensitive adhesive tape comprising a film substrate, on one surface of which a pressure-sensitive adhesive layer is formed.

7. The method of claim 1, wherein step (a) to step (d) are implemented by a roll-to-roll process.

8. An electrode prepared using the method of claim 1, comprising a current collector and an active material layer laminated on one surface or both surfaces of the current collector,
wherein a corner portion adjacent to the active material-nonlaminated portion and where an upper surface of the active material layer and a side wall surface forming a thickness of the active material layer meet includes a partial form of the cutting groove.

9. The electrode of claim 8, wherein the side wall surface forming a thickness of the active material layer is a side wall surface in a direction where an electrode tap is formed.

10. (canceled)
